(19) United States
(12) Patent Application Publication
(10) Pub. No.: US 2016/0040651 A1
(43) Pub. Date: Feb. 11, 2016

(54) METHODS OF MANUFACTURING ROTOR BLADES OF A WIND TURBINE

(71) Applicant: General Electric Company, Schenctady, NY (US)

(72) Inventors: Aaron A. Yarbrough, Clemson, SC (US); Christopher Daniel Caruso, Greenville, SC (US)

(21) Appl. No.: 14/453,658

(22) Filed: Aug. 7, 2014

(51) Int. Cl. F03D 1/06; B29D 99/00

(52) U.S. Cl. CPC F03D 1/0675; B29D 99/0025; B29K 2063/00

(57) ABSTRACT

Methods of manufacturing rotor blades for a wind turbine and rotor blades produced in accordance with such methods are disclosed. In one embodiment, the method includes forming a first spar cap of the rotor blade from a first resin material. Another step includes placing the first spar cap within a first shell mold of the rotor blade. A further step includes infusing a second resin material into the first shell mold to form a first shell member of the rotor blade. Thus, at least a portion of the first spar cap is infused within the first shell member. Further, the second resin material is different than the first resin material. The method also includes infusing the second resin material into a second shell mold to form a second shell member of the rotor blade. Another step includes bonding the first and second shell members together so as to form the rotor blade.

### FIELD OF THE INVENTION

The present subject matter relates generally to wind turbines and, more particularly, to methods of manufacturing rotor blade of a wind turbine.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is geared to a generator for producing electricity.

The rotor blades of the wind turbine may be manufactured using a variety of methods. Such methods are driven by different structural characteristics of the individual blade components. For example, the spar cap is driven by fiber-dominated strengths, whereas the blade shells, shear webs, and portions of the root ring are driven predominately by resin-dominated strengths. Conventional rotor blades are constructed with a common resin system for all components, e.g. spar caps, shear webs, root rings, and the blade shells. Thus, the common resin must be strong enough to account for the varying structural characteristics of the weakest of the individual parts.

For example, certain conventional manufacturing processes include constructing individual blade components of a strong, yet relatively expensive resin, e.g. an epoxy resin, and using a secondary infusion technique to bind the blade components together. Such a structure can have the disadvantage of possessing areas of critical structural bonding, thereby requiring a high strength bonding adhesive and sufficient preparation of the surfaces to be joined. In addition, such a manufacturing process may require well-trained workers to prevent the development of quality defects during the production process.

Further methods of manufacturing rotor blades include infusing the rotor blade and all of its components in a single infusion process using a weaker and therefore cheaper resin, such as a polyester resin. Thus, the blade shell and the spar caps are infused with the same resin and are not independent parts. The inferior fatigue and strength properties of lower cost resins, however, require more volume of laminate to be used, resulting in a heavier blade.

Accordingly, there is a need for improved methods of manufacturing rotor blades. For example, a method of manufacturing a rotor blade that reduces manufacturing costs and addresses the aforementioned issues would be advantageous.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method of manufacturing a rotor blade of a wind turbine. The method includes forming a first spar cap of the rotor blade from a fiber reinforced laminate composite and a first resin material. Another step includes placing the first spar cap within a first shell mold of the rotor blade. A further step includes placing a fiber reinforced laminate composite into the first shell mold atop the first spar cap and infusing a second resin material into the first shell mold to form a first shell member of the rotor blade. Thus, at least a portion of the first spar cap is bonded within the first shell member. Further, the second resin material is different than the first resin material. The method also includes infusing the second resin material into a second shell mold to form a second shell member of the rotor blade. Another step includes bonding the first and second shell members together so as to form the rotor blade.

In another aspect, the present subject matter is directed to a rotor blade of a wind turbine constructed of multiple resin materials. The rotor blade includes a body shell having first and second shell members extending between a leading edge and a trailing edge and at least one pre-fabricated spar cap at least partially bonded with one of the first or second shell members. In addition, the spar cap is formed from a first resin material, whereas the body shell is formed from one or more additional resin materials. Further, the additional resin materials have a higher matrix strength than the first resin material.

In yet another aspect, the present subject matter is directed to a method of manufacturing a rotor blade of a wind turbine. The method includes forming at least one rotor blade component from a fiber reinforced laminate composite and a first resin material, wherein the fiber reinforced laminate of the rotor blade component comprises unidirectional fibers. A next step includes forming a body shell of the rotor blade from a fiber reinforced laminate composite and a second resin material, wherein the fiber reinforced laminate composite of the body shell contains multi-directional fibers. Further, the second resin material has a higher matrix strength than the first resin material. In addition, the method includes bonding the rotor blade component to the body shell so as to form the rotor blade. For example, the body shell of the rotor blade may be formed by placing the fiber reinforced laminate composite into first and second shell molds and infusing the second resin material into the first and second shell molds so as to form first and second shell members, which may then be bonded together. Further, the second resin material has a higher matrix strength than the first resin material.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine according to the present disclosure;

FIG. 2 illustrates a flow diagram of one embodiment of a method of manufacturing a rotor blade according to the present disclosure;

FIG. 3 illustrates a schematic diagram of one of embodiment of a manufacturing process of a rotor blade according to the present disclosure;

FIG. 4 illustrates a perspective view of a rotor blade according to the present disclosure;

FIG. 5 illustrates a cross-sectional view of one embodiment of a rotor blade, particularly illustrating the structural components of the rotor blade, according to the present disclosure;

FIG. 6 illustrates a cross-sectional view of another embodiment of a rotor blade, particularly illustrating the structural components of the rotor blade, according to the present disclosure; and

FIG. 7 illustrates a flow diagram of another embodiment of a method of manufacturing a rotor blade according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present subject matter is directed to improved methods of manufacturing wind turbine rotor blades and rotor blades produced in accordance with such methods. More specifically, the present disclosure aims to construct different components of a wind turbine blade from different resins. As mentioned, conventional rotor blades are typically constructed of a common resin material for all components, e.g. spar caps, shear webs, root rings, blade shells, etc. The design of such components is driven by the different structural characteristics of each component. For example, the design of the spar cap is driven predominately by fiber-dominated strengths, whereas the design of the blade shells, shear webs, and portions of the root ring are driven predominately by resin-dominated strengths. The present disclosure, however, is directed to methods of manufacturing rotor blades that utilize less expensive and lower matrix strengths resin for components having unidirectional fibers (e.g. the spar cap, trailing edge reinforcements, etc.) and conventional resin materials having higher matrix strengths in rotor blade components containing multi-directional fibers (e.g. the primary shell, shear webs, root ring, etc.).

Rotor blade components manufactured according to the methods described herein provide many advantages not present in the cited art. For example, the rotor blades described herein can be manufactured at a lower cost than previous methods that utilize a single resin material, e.g. an epoxy-based resin. In addition, the rotor blades of the present disclosure have the same stiffness as blades manufactured from a single resin material. Further, the methods of manufacturing described herein provide rotor blades that have the same fiber-dominated tensile and compression strengths that are realized by those manufactured from a single resin material. Moreover, epoxy- based resins bond well to other resin systems (e.g. polyester resins) and are therefore ideal for usage in matrix strength driven applications.

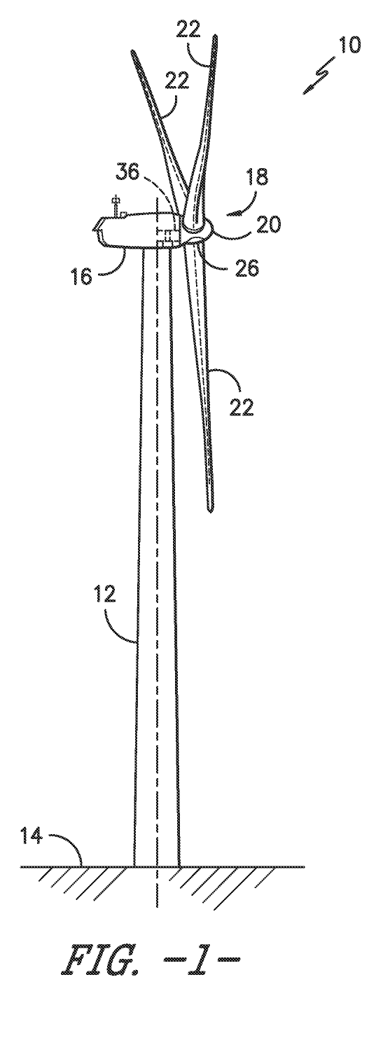

Referring to the drawings, FIG. 1 illustrates perspective view of a wind turbine 10 of conventional construction. The wind turbine 10 includes a tower 12 with a nacelle 14 mounted thereon. A plurality of rotor blades 16 are mounted to a rotor hub 18, which is, in turn, connected to a main flange that turns a main rotor shaft (not shown). The wind turbine power generation and control components may also be housed within the nacelle 14. It should be appreciated that the wind turbine 10 of FIG. 1 is provided for illustrative purposes only to place the present invention in an exemplary field of use. Thus, one of ordinary skill in the art should understand that the invention is not limited to any particular type of wind turbine configuration.

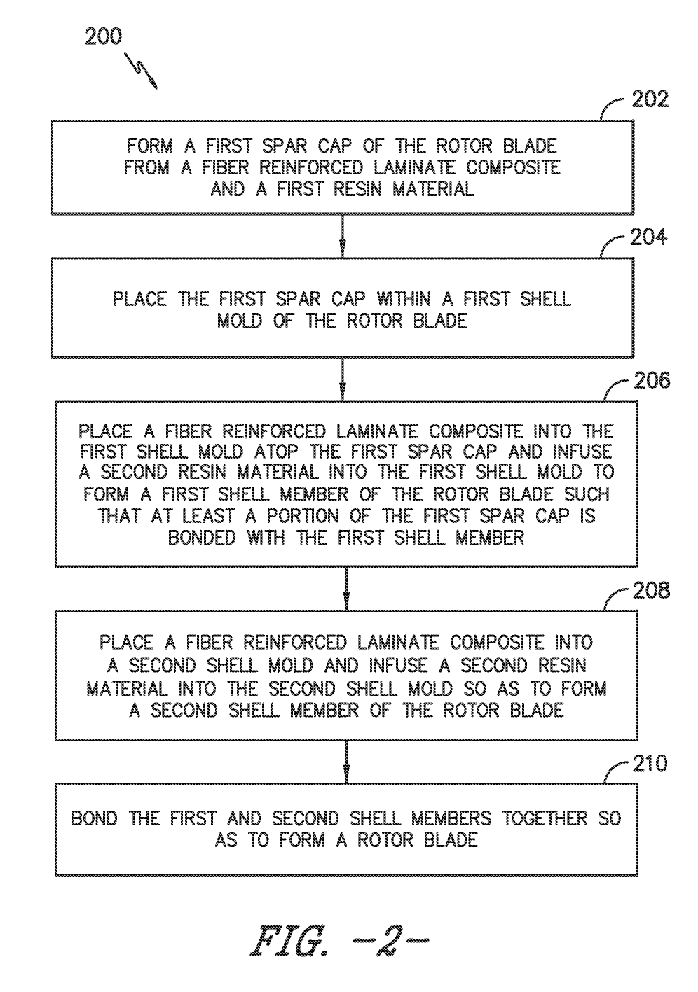

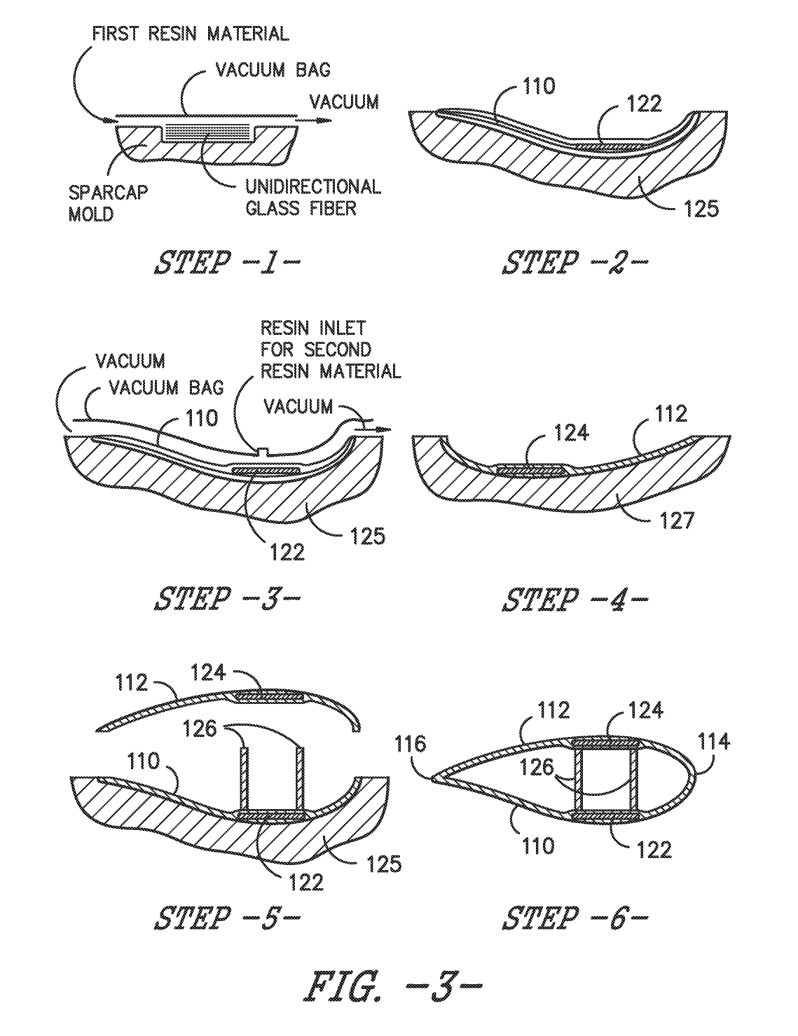

As indicated above, the present subject matter is generally directed to methods of manufacturing rotor blades of a wind turbine using multiple resin materials and rotor blades produced in accordance with such methods. Accordingly, one embodiment of a method 200 for manufacturing a rotor blade 100 suitable for the wind turbine 10 of FIG. 1 will generally be described with reference to FIG. 2 and will be explained in greater detail with reference to FIGS. 3-6. As shown in FIG. 2, the method 200 includes forming a first spar cap 122 of the rotor blade 100 from a fiber reinforced laminate composite and first resin material (step 202). More specifically, as shown in FIG. 3, the first spar cap 122 may be formed using vacuum infusion (STEP 1). For example, the fiber reinforced laminate composite layers may be first laid into the spar cap mold and then the first resin material may be infused into the spar cap mold to form the first spar cap 122.

A next step 204 of the method 200 includes placing the first spar cap 122 within a first shell mold 125 of the rotor blade 100. For example, as particularly illustrated in FIG. 3, the first spar cap 122 is first laid into the shell mold 125 such that a fiber reinforced laminate composite, e.g. dry fabric skin layers and core materials, may be subsequently laid thereon (STEP 2). For example, another step 206 of the method 200 may include placing a fiber reinforced laminate composite into the first shell mold 125 and infusing a second resin material into the shell mold 125 so as to form a first shell member 110 of the rotor blade 100. In particular embodiments, the second resin material of the blade shell member 110 is different than the first resin material of the spar cap 122. In certain embodiments, as shown in FIG. 3, the first shell member 110 may be formed by vacuum infusing the second resin material through the resin inlet (STEP 3). Thus, in certain embodiments, at least a portion of the first spar cap 122 is bonded within the first shell member 110.

Next, the method 200 includes a step 208 of placing a fiber reinforced laminate composite into a second shell mold 127 and infusing the second resin material into a second shell mold 127 so as to form a second shell member 112 of the rotor blade 100. For example, as shown in FIG. 3, the same process is repeated for constructing the second spar cap 124 and the second shell member 112 as the first shell member 110 using the second shell mold 127 or the same shell mold 125 (STEP 4). In certain embodiments, the first and second spar caps 122, 124 may be constructed of the same resin material or different resin materials depending on the fatigue performance of the material under predominately tensile or compressive loading. For example, the first spar cap 122 may correspond to the pressure side spar cap, which is predominately under tension during the lifetime of the rotor blade 100, whereas the second spar cap 124 may correspond to the suction side spar cap, which is predominately under compression loading. Composites usually have different strengths in fatigue for tension and compression; therefore, it is advantageous to utilize a stronger matrix material for the pressure side spar cap 122 and a weaker matrix material for the suction side spar cap 124. In addition, it should be understood that the different components of the rotor blade 100 as described herein may be constructed of any suitable resin material having suitable properties so as to provide the appropriate strength for the component. As such, any number of resin materials may be used when manufacturing the rotor blades 100 as described herein.

For example, in certain embodiments, rotor blade components containing predominately 0-degree fibers (i.e. 0-degrees measured along the axis 108 from the root tip 102 to the tip end 104) can be produced from weaker resin materials, whereas rotor blade components containing predominantly greater than 0-degree fibers (e.g. more than 10 degrees) as measured from axis 108 can be produced from stronger resin materials. Thus, in particular embodiments, the spar caps 122, 124 and the trailing edge reinforcement may be manufactured from a weaker resin, whereas the body shell 106 may be manufactured from a stronger resin.

In addition, the method 200 may include forming one or more shear webs 126 for the rotor blade 100 from an additional resin material and bonding the shear web(s) 126 between the opposing spar caps 122, 124 (STEP 5). It should be understood that the additional resin material may be any suitable resin as commonly known in the art and/or described herein. In addition, the shear webs 126 may be manufactured using any suitable processing method, such as for example, infusion molding. A further step 210 of the method 200 includes bonding the first and second shell members 110, 112 together so as to form the rotor blade 100, as particularly illustrated at STEP 6, using conventional methods. For example, in certain embodiments, the first and second shell members 110, 112 may be bonded together using an adhesive.

In particular embodiments, the first resin material utilized to construct the spar cap(s) 122, 124 may include a relatively inexpensive and economical resin material. For example, in certain embodiments, the first resin material may include a polyester, a vinyl ester, or similar. In addition, the spar caps 122, 124 may be formed from any suitable resin material that has material properties (e.g., strengths and/or moduli of elasticity) having a suitable compression and tension strength (also referred to as fiber-dominated strength) since the spar caps 122, 124 are typically more sensitive to tensile strength in the fiber direction. Further, the spar caps 122, 124 may generally be formed from the same resin material or different resin materials.

In contrast, in various embodiments, the second resin material utilized to construct the body shell 106 and/or the shear webs 126 may include a more expensive resin material than the first resin material. For example, the second resin material may include an epoxy, a dicyclopentadiene, a polyurethane, or similar. In addition, the body shell 106 may be formed from any suitable resin material that has material properties (e.g., strengths and/or moduli of elasticity) having a suitable resin strength (also referred to as matrix strength) since such components are typically more sensitive to tensile strength in the cross-fiber direction. Thus, in various embodiments, the first and second shell members 110, 112 may be formed from a laminate composite material, such as a carbon fiber reinforced laminate composite or a glass fiber reinforced laminate composite that is laid in the shell mold. In addition, one or more portions of the body shell 106 may be configured as a layered construction and may include a core material, formed from a lightweight material such as wood (e.g., balsa), foam (e.g., extruded polystyrene foam) or a combination of such materials, disposed between layers of laminate composite material. Further, as mentioned, the body shell 106 maybe formed by infusing the second resin material into first and second halves of a shell mold and allowing the resin material to cure (STEP 3).

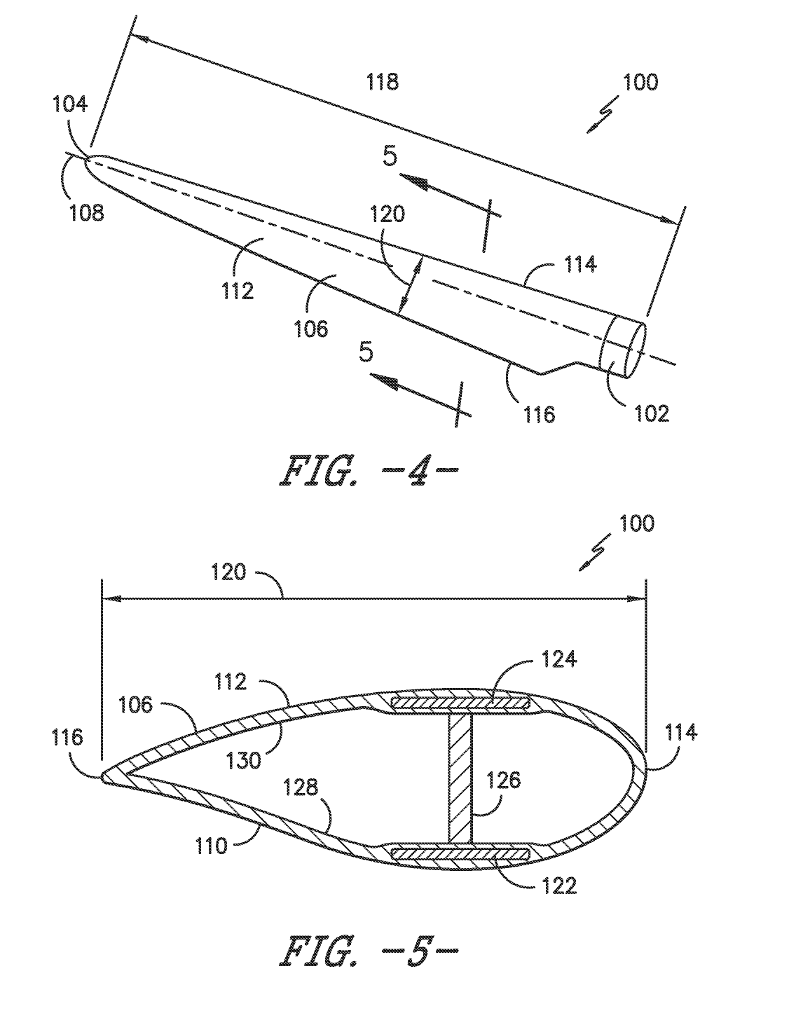

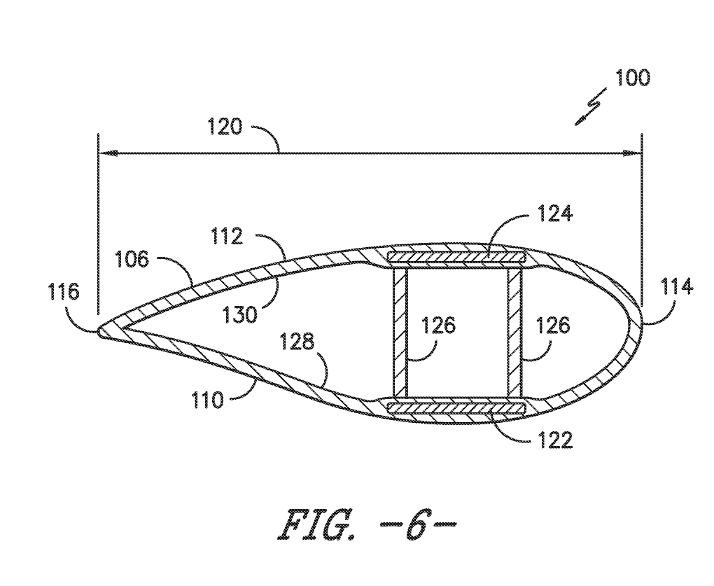

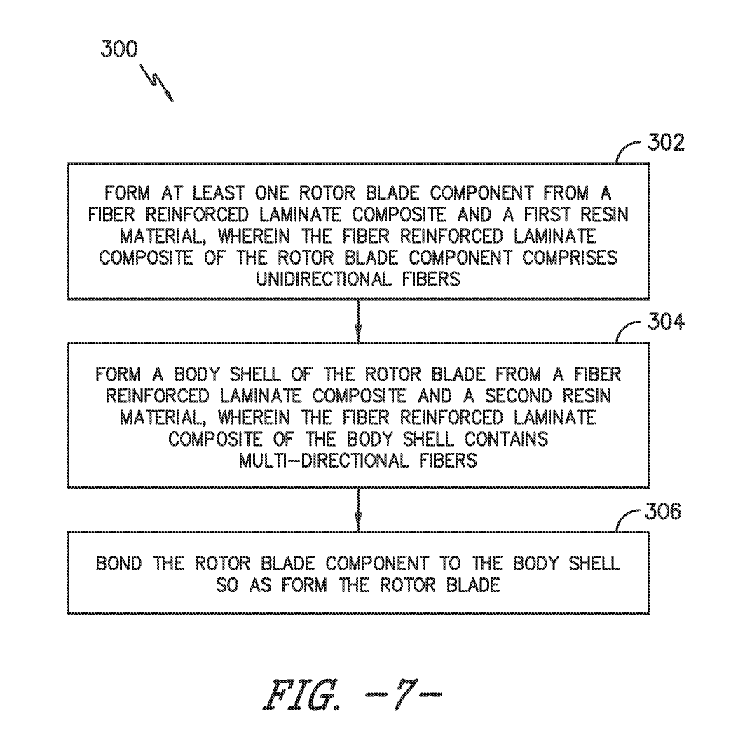

Referring to FIGS. 4-6, various embodiments of a rotor blade 100 manufactured in accordance with aspects of the present subject matter is illustrated. In particular, FIG. 4 illustrates a perspective view of one embodiment of the rotor blade 100 manufactured according to the present disclosure. FIG. 5 illustrates a cross-sectional view of the rotor blade 100 along the sectional line 5-5 shown in FIG. 4. FIG. 6 illustrates a cross-sectional view of another embodiment of the rotor blade 100 according to the present disclosure. As shown, the rotor blade 100 generally includes a root end 102 configured to be mounted or otherwise secured to the hub 20 (FIG. 1) of a wind turbine 10 and a tip end 104 disposed opposite the root end 102. The body shell 106 of the rotor blade 100 generally extends between the root end 102 and the tip end 104 along a longitudinal axis 108. The body shell 106 generally serves as the outer casing/covering of the rotor blade 100 and may define a substantially aerodynamic profile, such as by defining a symmetrical or cambered airfoil-shaped cross-section. The body shell 106 may also define a pressure side 110 and a suction side 112 extending between leading and trailing edges 114, 116 of the rotor blade 100. Further, the rotor blade 100 may have a span 118 defining the total length between the root end 100 and the tip end 102 and a chord 120 defining the total length between the leading edge 114 and the trialing edge 116. As is generally understood, the chord 120 may generally vary in length with respect to the span 118 as the rotor blade 100 extends from the root end 102 to the tip end 104.

In several embodiments, as described above, the body shell 106 may be formed from a plurality of shell members 110, 112. More specifically, the first shell member 110 may generally define the pressure side of the rotor blade 100 and the second shell member 112 may generally define the suction side of the rotor blade 100, with such shell members 110, 112 being secured to one another at the leading and trailing edges 114, 116 of the blade 100. Alternatively, the body shell 106 of the rotor blade 100 may be formed as a single, unitary component.

Additionally, as shown in FIG. 5, the rotor blade 100 includes one or more longitudinally extending internal structural components configured to provide increased stiffness, buckling resistance and/or strength to the rotor blade 100. For example, as mentioned, the rotor blade 100 may include a pair of longitudinally extending spar caps 122, 124 configured with the first and second shell members 110, 112 of the body shell 106, respectively. The spar caps 122, 124 may generally be designed to control the bending stresses and/or other loads acting on the rotor blade 100 in a generally spanwise direction (i.e. a direction parallel to the span 118 of the rotor blade 100) during operation of a wind turbine 10. For instance, bending stresses may occur on a rotor blade 100 when the wind loads directly on the pressure side 112 of the blade 100, thereby subjecting the pressure side 112 to spanwise tension and the suction side 110 to spanwise compression as the rotor blade 100 bends in the direction of the wind turbine tower 12 (FIG. 1). Further, as mentioned, one or more shear webs 126 may be disposed between the spar caps 122, 124 so as to form a beam-like configuration. For example, as shown in FIG. 5, one shear web 126 is configured between the spar caps 122, 124, whereas in FIG. 6, two shear webs 126 are configured between the spar caps 122, 124. It should be understood that the rotor blade 100 may include any number of and/or configuration of shear webs 126 so as to provide additional support to the rotor blade 100.

Referring now to FIG. 7, another embodiment of a method 300 for manufacturing a rotor blade component according to the present subject matter is illustrated. As shown, the method 300 includes a step 302 of forming at least one rotor blade component from a fiber reinforced laminate composite and a first resin material, wherein the fiber reinforced laminate composite of the rotor blade component contains unidirectional fibers. Another step 304 of the method 300 includes forming a body shell of the rotor blade from a fiber reinforced laminate composite and a second resin material, wherein the second resin material has a higher matrix strength than the first resin material, and wherein the fiber reinforced laminate composite of the body shell contains multi-directional fibers. Still another step 306 includes bonding the rotor blade component to the body shell so as to form the rotor blade.

As described herein, the rotor blade component may be any suitable component of the rotor blade, such as, for example, a pressure side spar cap, a suction side spar cap, a trailing edge reinforcement, an auxiliary spar cap, a shear web, or similar. As mentioned, methods of manufacturing according to the present disclosure, such as method 300 described above, are beneficial in that rotor blade components containing predominately 0-degree fibers measured along central axis 108 can be produced from weaker (and therefore cheaper) resin materials, whereas rotor blade components containing predominantly greater than 0-degree fibers (e.g. more than 10 degrees) as measured from axis 108 can be produced from stronger resin materials.

As mentioned herein, the step 304 of forming the body shell 106 of the rotor blade 100 may also include placing fiber reinforced laminate composite into first and second shell molds and infusing the second resin material into first and second shell molds so as to form first and second shell members 110, 112. As such, in one embodiment, the method 300 may include forming opposing spar caps 122, 124 of the rotor blade 100 from the first resin material, wherein a first spar cap is configured at least partially within the first shell member 110 and a second spar cap is configured at least partially within the second shell member 112. In addition, the method 300 may include bonding the first and second shell members 110, 112 together so as to form the rotor blade 100. It should be appreciated that, although the various method steps illustrated in FIGS. 2 and 7 are shown in a particular order, the steps may generally be performed in any sequence and/or order consistent with the disclosure provided herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of manufacturing a rotor blade of a wind turbine, the method comprising:
forming a first spar cap of the rotor blade from a fiber reinforced laminate composite and a first resin material;
placing the first spar cap within a first shell mold of the rotor blade;
placing a fiber reinforced laminate composite into the first shell mold atop the first spar cap and infusing a second resin material into the first shell mold so as to form a first shell member of the rotor blade such that a portion of the first spar cap is bonded with the first shell member, wherein the second resin material is different than the first resin material;
placing a fiber reinforced laminate composite into a second shell mold and infusing the second resin material into the second shell mold so as to form a second shell member of the rotor blade; and,
bonding the first and second shell members together so as to form the rotor blade.

2. The method of claim 1, further comprising forming an opposing, second spar cap of the rotor blade from a fiber reinforced laminate composite and an additional resin material.

3. The method of claim 2, wherein the first spar cap corresponds to a pressure side spar cap of the rotor blade and the second spar cap corresponds to a suction side spar cap of the rotor blade, wherein the first resin material of the first spar cap is different than the additional resin material of the second spar cap.

4. The method of claim 2, further comprising placing the second spar cap within the second shell mold of the rotor blade and placing the fiber reinforced laminate composite atop the second spar cap, wherein at least a portion of the second spar cap is bonded within the second shell member.

5. The method of claim 1, further comprising forming at least one shear web of the rotor blade from an additional resin material and bonding the at least one shear web between the first and second spar caps.

6. The method of claim 1, wherein the first resin material comprises at least one of a polyester or a vinyl ester.

7. The method of claim 1, wherein the second resin material comprises at least one of an epoxy, a dicyclopentadiene, or a polyurethane.

8. The method of claim 1, wherein the step of bonding the first and second shell members together so as to form the rotor blade further comprises bonding the first and second portions together using an adhesive.

9. A rotor blade of a wind turbine constructed of multiple resin materials, the rotor blade comprising:
a body shell comprising first and second shell members extending between a leading edge and a trailing edge; and,
at least one pre-fabricated spar cap bonded with at least one of the first shell member or the second shell member,
wherein the spar cap is formed from a first resin material and the body shell is formed from a second resin material, wherein the second resin material comprises a higher matrix strength than the first resin material.

10. The rotor blade of claim 9, further comprising opposing spar caps, wherein a first spar cap is bonded with the first shell member and a second spar cap is bonded with the second shell member.

11. The rotor blade of claim 10, wherein the first spar cap corresponds to a pressure side spar cap of the rotor blade and the second spar cap corresponds to a suction side spar cap of the rotor blade, wherein the second spar cap is formed from a different resin material than the first resin material.

12. The rotor blade of claim 10, further comprising at least one shear web formed from an additional resin material and bonded between the opposing spar caps.

13. The rotor blade of claim 9, wherein the first resin material comprises at least one of a polyester or a vinyl ester.

14. The rotor blade of claim 9, wherein the second resin material comprises at least one of an epoxy, a dicyclopentadiene, or a polyurethane.

15. A method of manufacturing a rotor blade of a wind turbine, the method comprising:
forming a rotor blade component from a fiber reinforced laminate composite and a first resin material, wherein the fiber reinforced laminate composite of the rotor blade component comprises unidirectional fibers;
forming a body shell of the rotor blade from a fiber reinforced laminate composite and a second resin material, wherein the second resin material comprises a higher matrix strength than the first resin material, and wherein the fiber reinforced laminate composite of the body shell comprises multi-directional fibers; and
bonding the rotor blade component to the body shell so as to form the rotor blade.

16. The method of claim 15, wherein the rotor blade component comprises at least one of a pressure side spar cap, a suction side spar cap, a trailing edge reinforcement, an auxiliary spar cap, or a shear web.

17. The method of claim 15, wherein forming the body shell of the rotor blade further comprises placing fiber reinforced laminate composite into first and second shell molds and infusing the second resin material into the first and second shell molds so as to form first and second shell members.

18. The method of claim 17, further comprising forming opposing spar caps of the rotor blade, wherein at least a portion of the first spar cap is configured within the first shell member and at least a portion of the second spar cap is configured within the second shell member.

19. The method of claim 18, further comprising bonding the first and second shell members together so as to form the rotor blade.

20. The method of claim 15, wherein the first resin material comprises at least one of a polyester or a vinyl ester, and wherein the second resin material comprises at least one of an epoxy, a dicyclopentadiene, or a polyurethane.
